(19) United States
(12) Patent Application Publication
(10) Pub. No.: US 2014/0017606 A1
(43) Pub. Date: Jan. 16, 2014

(54) FERRITE PARTICLES AND ELECTROPHOTOGRAPHIC CARRIER AND ELECTROPHOTOGRAPHIC DEVELOPER USING SAME

(71) Applicants: Tomoya Yamada, Okayama-city (JP); Tomohide Iida, Okayama-city (JP)

(72) Inventors: Tomoya Yamada, Okayama-city (JP); Tomohide Iida, Okayama-city (JP)

(73) Assignees: DOWA IP CREATION CO., LTD, Okayama (JP); DOWA ELECTRONICS MATERIALS CO., LTD., Tokyo (JP)

(21) Appl. No.: 14/005,715

(22) PCT Filed: Mar. 19, 2012
(86) PCT No.: PCT/JP2012/056955

§ 371 Date: Sep. 17, 2013

(30) Foreign Application Priority Data
Mar. 24, 2011 (JP) 2011-066647

(51) Int. Cl. G03G 9/107

(52) U.S. Cl. CPC G03G 9/107; G03G 9/1075
USPC 430/106.1; 430/111.31; 430/111.33

(57) ABSTRACT

A material expressed as a composition formula M_{X}Fe_{3-X}O₄ (where M is at least one of Mg and Mn, and 0≦X≦1) is a main component, and as a total amount, 0.1 to 2.5 weight percent of at least one of a Sr element and a Ca element is contained. Here, when ferrite particles are used as a carrier, in terms of obtaining a higher image density, the fluidity of the ferrite particles magnetized under a magnetic field of 1000/(4π) kA/m (1000 oersteds) is preferably 40 seconds or more. The residual magnetization σr is preferably 3 Am²/kg or more.

### TECHNICAL FIELD

The present invention relates to ferrite particles and an electrophotographic carrier and an electrophotographic developer using such ferrite particles.

### BACKGROUND ART

For example, in an image formation device using an electrophotographic system, such as a facsimile, a printer or a copying machine, an electrostatic latent image formed on the surface of an electrostatic latent image carrying member (which may hereinafter be referred to as a “photoconductive member”) is visualized with a developer, and the visualized image is transferred to a sheet or the like and is then fixed by being heated and pressurized. In terms of increasing image quality and achieving colorization, as the developer, a so-called two-component developer that contains a carrier and a toner is widely used.

Development using such a two-component developer is performed as follows. A developer carrying member (which may hereinafter be referred to as a “development sleeve”) that incorporates a plurality of magnetic poles and that carries the developer on its surface and a photoconductive member are arranged a predetermined distance apart substantially parallel to and opposite each other, in a region where the photoconductive member and the development sleeve are opposite each other (which may hereinafter be referred to as a “development region”), a magnetic brush in which the carriers are aggregated and its bristles are raised is formed on the development sleeve and a development bias voltage is applied between the photoconductive member and the development sleeve to adhere the toner to the electrostatic latent image on the surface of the photoconductive member.

In order to increase image quality, for example, patent document 1 proposes that an alternating electric field is formed between a development sleeve and a photoconductive member to develop an electrostatic latent image with a toner retained by a magnetic brush and a toner carried on the development sleeve. Furthermore, patent document 2 proposes that an electrostatic latent image is developed with a carrier of small-diameter particles and low magnetization.

### RELATED ART DOCUMENT

### Patent Document

Patent document 1: JP-A-62-63970
Patent document 2: JP-A-2010-66490

### DISCLOSURE OF THE INVENTION

### Problems to be Solved by the Invention

Incidentally, in recent years, in order to meet a requirement from the market that an image formation speed in an image formation device is increased, there has been a tendency that the speed of rotation of a development sleeve is increased to increase the amount of developer supplied to a development region per unit time.

However, when a carrier of particles having a small diameter of 50 μm or less is used, even if the speed of rotation of the development sleeve is increased to increase the amount of developer supplied to the development region, it may be impossible to obtain an sufficient image density.

In view of the conventional problem described above, the present invention is made; an object of the present invention is to provide ferrite particles in which, when they are used as the carrier of an electrophotographic image formation device, even if an image formation speed is increased, a sufficient image density is obtained.

### Means for Solving the Problem

To achieve the above object, according to the present invention, there are provided ferrite particles, where a material expressed as a composition formula M_{X}Fe_{3-X}O₄ (where M is at least one of Mg and Mn, and 0≦X≦1) is a main component, and as a total amount, 0.1 to 2.5 weight percent of at least one of a Sr element and a Ca element is contained.

Here, when the ferrite particles are used as a carrier, in terms of obtaining a higher image density, the fluidity of the ferrite particles magnetized under a magnetic field of 1000/(4π) kA/m (1000 oersteds) is preferably 40 seconds or more. A method of measuring the “fluidity” will be described in examples that will be discussed later.

The residual magnetization σr is preferably 3 Am²/kg or more. A method of measuring the “residual magnetization” will be described in examples that will be discussed later.

According to the present invention, there is provided an electrophotographic carrier, where the surface of the ferrite particles of any one of what have been described is coated with a resin.

Furthermore, according to the present invention, there is provided an electrophotographic developer containing the electrophotographic carrier described above and a toner.

### Advantages of the Invention

Since the ferrite particles of the present invention, a material expressed as a composition formula M_{X}Fe_{3-X}O₄ (where M is at least one of Mg and Mn, and 0≦X≦1) is a main component, and as a total amount, 0.1 to 2.5 weight percent of at least one of a Sr element and a Ca element is contained, when the ferrite particles are used as a carrier, the carrier is moved such that in a development region, the carrier at the top end portion of a magnetic brush and the carrier at the base portion are circulated, and thus, among toner retained by the carrier and toner on a development sleeve, the amount of toner that can be moved to a photoconductive member is increased, with the result that it is possible to obtain a sufficient image density.

### BRIEF DESCRIPTION OF DRAWINGS

FIG. 1 A schematic diagram showing an example of a development device when the ferrite particles of the present invention are used as a carrier;

FIG. 2 A diagram schematically showing the behavior of the carrier in a development region.

### DESCRIPTION OF EMBODIMENTS

The present inventors et al. have thoroughly made examinations so as to obtain a sufficient image density even if an image formation speed is increased, and consequently finds the followings to reach the present invention. When a carrier is significantly moved such that in a development region, the carrier at the top end of a magnetic brush and the carrier at the base portion are circulated, a toner retained by the carrier, the so-called amount of toner which can be developed is greatly increased, and thus it is possible to supply a sufficient amount of toner to an electrostatic latent image on a photoconductive member, with the result that a high image density is obtained; the composition and the property of ferrite particles serving as the core member of the carrier greatly affect such significant movement that in the development region, the carrier at the top end of the magnetic brush and the carrier at the base portion are circulated.

Specifically, the ferrite particles of the present invention are highly characterized in that they have, a main component, a material expressed as a composition formula M_{X}Fe_{3-X}O₄ (where M is at least one of Mg and Mn, and 0≦X≦1), and contains, as a total amount, 0.1 to 2.5 weight percent of at least one of a Sr element and a Ca element.

The present inventors et al. currently think that the reason why, when a predetermined amount of at least one of the Sr element and the Ca element is contained, the carrier forming the magnetic brush in the development region is significantly moved is the following mechanism. When a predetermined amount of at least one of the Sr element and the Ca element having relatively high magnetization is contained in the ferrite particles serving as the carrier core member, the residual magnetization of the carrier core member and the carrier is increased, and thus the coupling between the particles of the carrier forming the bristles of the magnetic brush on the surface of a development sleeve is increased whereas the bristles of the magnetic brush repel each other. Consequently, the fluidity of the carrier in the development region is decreased, and, when the magnetic brush is brought into sliding contact with the photoconductive member in the development region, not only the top end portion of the magnetic brush in contact with the photoconductive member is moved but also the carrier at the top end portion of the magnetic brush and the carrier at the base portion are significantly moved such that they are circulated.

In the ferrite particles of the present invention, it is important to make the total amount of the Sr element and/or the Ca element fall within a range of 0.1 to 2.5 weight percent. When the total amount of the element mentioned above is less than 0.1 weight percent, if the ferrite particles are used as the carrier, the significant movement is not made in the development region, and only the top end portion of the magnetic brush in contact with the photoconductive member is moved. On the other hand, when the total amount of the element mentioned above exceeds 2.5 weight percent, the magnetization of the ferrite particles is lowered by an impurity, and, if the ferrite particles are used as the carrier, the scattering of the carrier or the like occurs. More preferably, the total amount of the element mentioned above falls within a range of 0.1 to 2.0 weight percent.

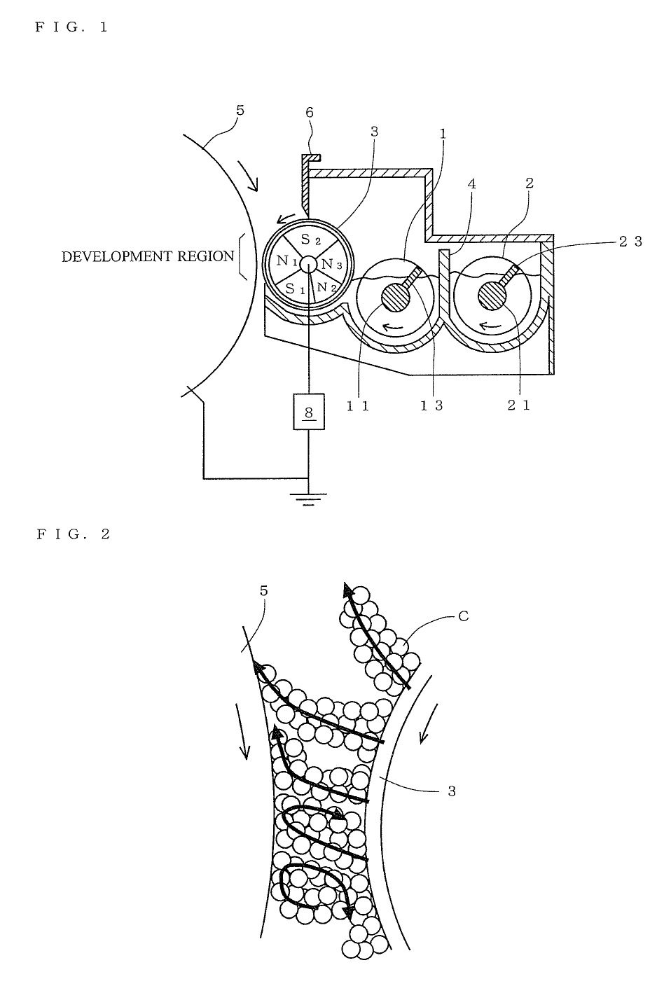

When the ferrite particles of the present invention are used as the carrier, in terms of obtaining a higher image density, the fluidity of the ferrite particles magnetized under a magnetic field of 1000/(4π) kA/m (1000 oersteds) is preferably 40 seconds or more. More preferably, the fluidity is 45 seconds or more. On the other hand, within, for example, a development device shown in FIG. 1, which will be described later, in terms of, for example, reducing the circulation/agitation torque of a developer containing the carrier, the fluidity of the ferrite particles before being magnetized (or after being demagnetized) is preferably a short period of time.

The residual magnetization σr of the ferrite particles of the present invention is preferably 3 Am²/kg or more. When the residual magnetization σr is 3 Am²/kg or more, the coupling between the ferrite particles is increased, and the frictional resistance of the particles is increased, with the result that the carrier at the top end portion of the magnetic brush and the carrier at the base portion are significantly moved such that they are circulated.

The diameter of the ferrite particle of the present invention is not particularly limited; the average particle diameter is preferably about a few tens of micrometers to a few hundreds of micrometers. When the ferrite particles of the present invention are used as the carrier core member, the particle diameter is preferably about a few tens of micrometers, and the particle distribution is preferably sharp.

The ferrite particles of the present invention can be used for various applications; for example, they can be used as an electrophotographic development carrier, an electromagnetic wave absorption member, an electromagnetic shielding member material powder, a rubber, a plastic filler/reinforcing member, a pint, a paint/adhesive matte material, a filler, a reinforcing member or the like. Among them, in particular, they are preferably used as an electrophotographic development carrier.

A method of manufacturing the ferrite particles of the present invention is not particularly limited; a manufacturing method that will be described below is preferably used.

A Fe component raw material and an M component raw material and a Sr component raw material and a Ca component raw material serving as additives are weighed, are put into a dispersion medium and are mixed, with the result that slurry is produced. The M is a metal element of at least one of Mg and Mn. As the Fe component raw material, Fe₂O₃ or the like is preferably used. As the M component raw material, when the M is Mg, MgO, Mg(OH)₂ or MgCO₃ can be used; as the M component raw material, when the M is Mn, MgCO₃, Mn₃O₄ or the like can be preferably used. As the Sr component raw material, SrO, SrCO₃, SrTiO₃ or the like can be preferably used. As the Ca component raw material, CaO, Ca(OH)₇, CaCO₃ or the like can be preferably used.

As the dispersion medium used in the present invention, water is preferably used. The dispersion medium may contain the Fe component raw material, the M component raw material, the Sr component raw material and the Ca component raw material described above and as necessary, a binder, a dispersion agent and the like. As the binder, for example, polyvinyl alcohol can be preferably used. The amount of binder contained is preferably set at a concentration of about 0.5 to 2 weight percent in the slurry. As the dispersion agent, for example, polycarboxylic acid ammonium or the like can be preferably used. The amount of dispersion agent contained is preferably set at a concentration of about 0.5 to 2 weight percent in the slurry. Others such as a lubricant and a sintering accelerator may be contained.

The solid content concentration of the slurry preferably falls within a range of 50 to 90 weight percent. Since the amounts of Sr component raw material and Ca component raw material that are added are very low with respect to the total weight of the Fe component raw material and the M component raw material, the Sr component raw material and the Ca component raw material may first be dispersed in the dispersion medium, and then the Fe component raw material and the M component raw material may be dispersed in the dispersion medium. Thus, the raw materials can be uniformly dispersed. Before the Fe component raw material, the M component raw material, the Sr component raw material and the Ca component raw material are put into the dispersion medium, as necessary, milling and mixing processing may be performed.

Then, the slurry produced as described above is subjected to wet milling. For example, the wet milling is performed for a predetermined time using a ball mill or a vibration mill. The average particle diameter of the raw material after being milled is preferably 10 μm or less, and is more preferably 1 μm or less. In the vibration mill and the ball mill, a medium having a predetermined particle diameter is preferably present. Examples of the material of the medium include an iron-based chrome steel and oxides such as zirconia, titania and alumina. The form of the milling process may be either of a continuous type and a batch type. The particle diameter of the milled product is adjusted by the milling time, the rotation speed, the material quality/particle diameter of the medium used or the like.

Then, the milled slurry is sprayed and dried and is thereby pelletized. Specifically, the slurry is introduced into a spray drying device such as a spray drier, is sprayed into an atmosphere and is thereby pelletized into spheres. The temperature of the atmosphere at the time of the spray drying preferably falls within a range of 100 to 300° C. In this way, it is possible to obtain the spherical pelletized product having a particle diameter of 10 to 200 μm. Preferably, from the obtained pelletized product, coarse and fine particles are removed with a vibrating screen or the like, and the particle distribution is made sharp.

Then, the pelletized product is put into a furnace heated to 800° C. or more, and is burned by a general method for synthesizing ferrite particles, with the result that the ferrite particles are produced. When the burning temperature is 800° C. or more, the sintering proceeds, and the shape of the produced ferrite particles is maintained. The upper limit value of the burning temperature is preferably 1500° C., is more preferably 1200° C. and is further preferably 1000° C. The reason why it is preferable to lower the burning temperature within the range in which the sintering proceeds is that the growth of crystal is reduced to leave a large number of projections and recesses on the surface of the particles. That is because the formation of projections and recesses on the surface of the ferrite particles lowers the fluidity, and, when the ferrite particles are used as the carrier core member, the carrier is significantly moved in the development region.

Then, the obtained burned product is disintegrated. Specifically, for example, the burned product is disintegrated with a hammer mill or the like. The form of the disintegrating process may be either of a continuous type and a batch type. As necessary, in order to make the particle diameter fall within a predetermined range, classification may be performed. As a classification method, a conventional known method such as air classification and sieve classification can be used. After primary classification is performed with an air classifier, the particle diameter may be made to fall within the predetermined range with a vibration sieve or an ultrasonic sieve. Furthermore, after the classification process, non-magnetic particles may be removed with a magnetic field beneficiation machine.

Thereafter, as necessary, the resistance may be increased by heating, in an oxidizing atmosphere, the powder (the burned product) after the classification to form an oxide film on the surface of the particles. The oxidizing atmosphere may be either an air atmosphere or an atmosphere of mixture of oxygen and nitrogen. The heating temperature preferably falls within a range of 200 to 800° C., and more preferably falls within a range of 250 to 600° C. The heating time preferably falls within 30 minutes to 5 hours.

When the ferrite particles of the present invention produced as described above are used as the electrophotographic development carrier, though the ferrite particles can be used as the electrophotographic development carrier without being processed, in terms of charging, the surface of the ferrite particles is preferably coated with a resin.

As the resin with which the surface of the ferrite particles is coated, a conventional known resin can be used; examples of the resin include a silicone resin, polyethylene, polypropylene, polyvinyl chloride, poly-4-methylpentene-1, polychloride vinylidene, an ABS (acrylonitrile-butadiene-styrene) resin, polystyrene, a (meth) acrylic-based resin, a polyvinyl alcohol-based resin, thermoplastic elastomers based on polyvinyl chloride, polyurethane, polyester, polyamide, polybutadiene and the like and a fluorine silicone-based resin.

In order for the surface of the ferrite particles to be coated with a resin, the solution or the dispersion liquid of the resin is preferably applied to the ferrite particles. As a solvent for the coating solution, one or two or more types of solvents below can be used: aromatic hydrocarbon-based solvents such as toluene and xylene; ketone-based solvents such as acetone, methylethyl ketone, methylisobutyl ketone and cyclohexanone; cyclic ether solvents such as tetrahydrofuran and dioxane; alcohol-based solvents such as ethanol, propanol and butanol; cellosolve-based solvents such as ethyl cellosolve and butyl cellosolve; ester-based solvents such as ethyl acetate and butyl acetate; and amide-based solvents such as dimethyl formamide and dimethyl acetamide. The concentration of the resin component in the coating solution generally falls within a range of 0.001 to 30 weight percent and particularly preferably falls within a range of 0.001 to 2 weight percent.

As the method of coating the ferrite particles with a resin, for example, a spray dry method, a fluidized bed method, a spray dry method using a fluidized bed, an immersion method or the like can be used. Among them, the fluidized bed method is particularly preferable in that it is possible to effectively perform coating with a small amount of resin. The resin coating amount can be adjusted by, for example, the amount of resin solution sprayed or a spraying time when the fluidized bed method is used.

With respect to the particle diameter of the carrier, its volume average particle diameter is generally 10 to 200 and is particularly preferably 10 to 50 μm. The apparent density of the carrier generally preferably falls within a range of 1.0 to 2.5 g/cm³ when a magnetic material is a main component, though it differs depending on the composition of the magnetic member, the surface structure and the like.

The electrophotographic developer of the present invention is formed by mixing the carrier produced as described above and the toner. The mixing ratio between the carrier and the toner is not particularly limited, and is preferably determined, as necessary, by development conditions of the development device used and the like. In general, the concentration of the toner in the developer preferably falls within a range of 1 to 15 weight percent. This is because, when the toner concentration is less than 1 weight percent, the image density is excessively decreased whereas when the toner concentration exceeds 15 weight percent, it is likely that the toner is disadvantageously scattered within the development device to soil the interior of the device and to adhere the toner to the background part of transfer paper or the like. More preferably, the toner concentration falls within a range of 3 to 10 weight percent.

The toner used in the present invention can be manufactured by a known method itself such as a polymerization method, a milling classification method, a melting pelletization method or a spray pelletization method, and is formed by containing a coloring agent, a mold release agent, a charge control agent and the like in a binder resin whose main component is a thermoplastic resin.

Examples of the binder resin include a polyester resin, a styrene-based polymer, an acrylic-based polymer, a styrene-acrylic-based polymer, chlorinated polystyrene, polypropylene, an olefin-based polymer such as an ionomer, polyvinyl chloride, a polyester-based resin, polyamide, polyurethane, an epoxy resin, a diallyl phthalate resin, a silicone resin, a ketone resin, a polyvinyl butyral resin, a phenol resin, a rosin-modified phenol resin, a xylene resin, a rosin-modified maleic acid resin and a rosin ester. Among them, a polyester resin is particularly preferably used.

A polyester resin is mainly obtained by the condensation polymerization of a polycarboxylic acid and a polyhydric alcohol.

Examples of the polycarboxylic acid used in the polyester resin include: aromatic polycarboxylic acids such as phthalic acid, isophthalic acid, terephthalic acid, 1,2,4-benzene tricarboxylic acid, 2,5,7-naphthalene tricarboxylic acid, 1,2,4-naphthalene tricarboxylic acid and pyromellitic acid; aliphatic dicarboxylic acids such as maleic acid, fumaric acid, succinic acid, adipic acid, sebacic acid, malonic acid, azelaic acid, mesaconic acid, citraconic acid and glutaconic acid; alicyclic dicarboxylic acids such as cyclohexane dicarboxylic acid and methyl nadic acid; and anhydrides and lower alkyl esters of these carboxylic acids. One or two or more types of these are used.

The content of trivalent and more components depends on the degree of cross-linking; in order to obtain the desired degree of cross-linking, it is possible to adjust the amount of addition thereof. In general, the content of trivalent and more components is preferably 15 mol percent or less.

Examples of the polyhydric alcohol used in the polyester resin include: alkylene glycols such as ethylene glycol, 1,2-propylene glycol, 1,3-propylene glycol, 1,4-butanediol, 1,4-butenediol, neopentyl glycol, 1,5-pentane glycol and 1,6-hexane glycol; alkylene ether glycols such as diethylene glycol, triethylene glycol, dipropylene glycol, polyethylene glycol, polypropylene glycol and polytetramethylene glycol; polyhydric alicyclic alcohols such as 1,4-cyclohexanedimethanol and hydrogenated bisphenol A; and bisphenols such as bisphenol A, bisphenol F and bisphenol S and alkylene oxides of the bisphenols. One or two or more types of these are used.

In order to adjust the molecular weight and control the reaction, a monocarboxylic acid and a mono alcohol may be used as necessary. Examples of the monocarboxylic acid include benzoic acid, p-hydroxybenzoic acid, toluene carboxylic acid, salicylic acid, acetic acid, propionic acid and stearic acid. Examples of the mono alcohol include benzyl alcohol, toluene-4-methanol and cyclohexane methanol.

In the polyester resin used in the present invention, its glass-transition temperature preferably falls within a range of 45 to 90° C. When the glass-transition temperature is less than 45° C., the toner is likely to solidify within a toner cartridge or the development device whereas when the glass-transition temperature exceeds 90° C., the toner is likely to be insufficiently fixed to a transfer member.

As the binder resin of the toner used in the present invention, as necessary, not only the polyester resin described above but also a combination of the polyester resin with another resin may be used.

As the coloring agent contained in the binder resin, for example, the followings can be used: as black pigments, carbon blacks such as acetylene black, orchid black and aniline black; as yellow pigments, chrome yellow, zinc yellow, cadmium yellow, yellow iron oxide, mineral fast yellow, nickel titanium yellow, navel yellow, naphthol yellow S, Hansa Yellow G, Hansa yellow 100, benzidine yellow G, benzidine yellow GR, quinoline yellow lake, permanent yellow NCG and tartrazine lake; as orange pigments, chrome orange, molybdenum orange, permanent orange GTR, pyrazolone orange, vulcan orange, indanthrene brilliant orange RK, benzidine orange G and indanthrene brilliant orange GK; as red pigments, colcothar, cadmium red, minium, cadmium mercury sulfide, permanent red 4R, lithol red, pyrazolone red, watching red calcium salt, lake red D, brilliant carmine 6B, eosin lake, rhodamine lake B, alizarin lake and brilliant carmine 3B; as purple pigments, manganese violet, fast violet B and methyl violet lake; as blue pigments, prussian blue, cobalt blue, alkali blue lake, victoria blue lake, phthalocyanine blue, metal-free phthalocyanine blue, partially chlorinated phthalocyanine blue, fast sky blue and indathrene blue BC; as green pigments, chrome green, chromium oxide, pigment green B, malachite green lake and final yellow green G; as white pigments, zinc white, titanium oxide, antimony white and zinc sulfide; and as white pigments, barite powder, barium carbonate, clay, silica, white carbon, talc and alumina white. The content of the coloring agent preferably falls within a range of 2 to 20 weight parts and more preferably falls within a range of 5 to 15 weight parts with respect to 100 weight parts of the binder resin.

As the mold release agent contained in the binder resin, there are various types of waxes, low molecular weight olefin-based resins and the like. The number average molecular weight (Mn) of the olefin-based resin preferably falls within a range of 1000 to 10000, and particularly preferably falls within a range of 2000 to 6000. As the olefin-based resin, polypropylene, polyethylene and a propylene-ethylene copolymer are used; polypropylene is particularly preferably used.

As the charge control agent, a generally used charge control agent is used. As a positively-charged charge control agent, for example, the followings can be used: a nigrosine dye, a fatty acid modified nigrosine dye, a carboxyl group-containing fatty acid modified nigrosine dye, a quaternary ammonium salt, an amine-based compound, an organometallic compound and the like. As a negatively-charged charge control agent, for example, a metal complex dye, a salicylic acid derivative and the like can be used.

With respect to the particle diameter of the toner, in general, its volume average particle diameter measured with a Coulter counter preferably falls within a range of 5 to 15 μm, and particularly preferably falls within a rang e of 7 to 12 μm.

A modifier can be added, as necessary, to the surface of the toner particles. Examples of the modifier include silica, an aluminum oxide, a zinc oxide, a titanium oxide, a magnesium oxide, calcium carbonate, polymethyl methacrylate and the like. One of or a combination of two or more types of these can be used.

The mixing of the carrier and the toner can be performed using a conventional known mixing device. For example, a Henschel mixer, a V-type mixer, a tumbler mixer, a hybridizer and the like can be used.

The development method using the developer of the present invention is not particularly limited; a magnetic brush development method is preferably used. FIG. 1 shows a schematic diagram showing an example of the development device that performs magnetic brush development. The development device shown in FIG. 1 includes: a development sleeve 3 that incorporates a plurality of magnetic poles and that can freely rotate; a restriction blade 6 that restricts the amount of developer on the development sleeve 3 transported to the a development portion; two screws 1 and 2 that are arranged parallel to the horizontal direction and that agitate and transport the developer in opposite directions; and a partition plate 4 that is formed between the two screws 1 and 2, that allows the movement of the developer from one screw to the other screw at both end portions of the screws and that prevents the movement of the developer in the portions other than the end portions.

The two screws 1 and 2 are configured by forming helical blades 13 and 23 on shaft portions 11 and 21 at the same inclination angle, are rotated with an unillustrated drive mechanism in the same direction and transport the developer in opposite directions. At both end portions of the screws 1 and 2, the developer is moved from one screw to the other screw. In this way, the developer formed with the toner and the carrier is constantly circulated and agitated within the device.

On the other hand, the development sleeve 3 includes, within a metallic tubular member with projections and recesses of a few micrometers on the surface, as magnetic generation means, a stationary magnet where five magnetic poles, namely, a development magnetic pole N₁, a transport magnetic pole S₁, a separation magnetic pole N₂, a pumping magnetic pole N₃ and a blade magnetic pole S₂ are sequentially arranged. When the development sleeve 3 is rotated in a direction indicated by an arrow, the developer is pumped from the screw 1 to the development sleeve 3 by the magnetic force of the pumping magnetic pole N₃. The developer carried on the surface of the development sleeve 3 is restricted in layer by the restriction blade 6, and is thereafter transported to the development region.

In the development region, a bias voltage obtained by superimposing a direct-current voltage on an alternating-current voltage is applied from a transfer voltage power supply 8 to the development sleeve 3. The direct-current voltage component of the bias voltage is made to have a potential between a background portion potential and an image portion potential on the surface of a photoconductive drum 5. The background portion potential and the image portion potential are made to be potentials between the maximum value and the minimum value of the bias voltage. The peak-to-peak voltage of the bias voltage preferably falls within a range of 0.5 to 5 kV, and the frequency preferably falls within a range of 1 to 10 kHz. The waveform of the bias voltage may be any of a rectangular wave, a sin wave, a triangular wave and the like. Thus, in the development region, the toner and the carrier are vibrated, the toner is adhered to an electrostatic latent image on the photoconductive drum 5 and development is performed.

Thereafter, the developer on the development sleeve 3 is transported into the device by the transport magnetic pole S₁, is separated from the development sleeve 3 by the separation magnetic pole N₂, is circulated and transported again within the device by the two screws 1 and 2 and is mixed and agitated with the developer that has not been subjected to the development. Then, the developer is newly supplied from the screw 1 to the development sleeve 3 by the pumping magnetic pole N₃.

FIG. 2 schematically shows the behavior of the developer (mainly, the carrier) in the development region of the device configured as described above. By the magnetic field of the development magnetic pole N₁, a plurality of carriers C continuous on the development sleeve 3 are formed into the shape of a brush, and are gradually raised. When the carriers C are raised, the toner enclosed by the aggregation of the carriers C is more likely to be scattered and moved from the open space to the photoconductive drum 5. Then, the carriers C in which the bristles are raised are higher than a gap between the development sleeve 3 and the photoconductive drum 5 in the development region, and the top end portions of the magnetic brush make contact with and stroke the surface of the photoconductive drum 5. Here, the toner carried by the carriers C is moved to the surface of the photoconductive drum 5 and is adhered to the electrostatic latent image and the electrostatic latent image is visualized.

As described above, the carrier of the present invention has a low fluidity as compared with a normal carrier, and, by frictional resistance on the surface of the photoconductive drum 5, frictional resistance between the particles of the carriers C and the like, the carriers C at the top end portion of the magnetic brush are moved to the side of the development sleeve 3, and simultaneously the carriers at the base portion of the magnetic brush are moved to the side of the photoconductive drum 5. Since the toner carried on the surface of the carriers C and the surface of the development sleeve 3 is moved to the surface of the photoconductive drum 5 by the significant movement of the carriers C described above, even if the image formation speed is increased, a sufficient amount of toner can be supplied to the electrostatic latent image, with the result that the image density is prevented from being lowered.

A ratio Vs/Vp between the circumferential velocity Vs of the development sleeve 3 and the circumferential velocity Vp of the photoconductive drum 5 preferably falls within a range of 0.9 to 4. When the circumferential velocity ratio Vs/Vp is less than 0.9, the amount of toner that can be supplied to the electrostatic latent image on the photoconductive drum 5 is excessively lowered, and thus the image density is likely to be reduced. On the other hand, when the circumferential velocity ratio Vs/Vp exceeds 4, the number of times the surface of the photoconductive drum 5 is stroked by the magnetic brush is excessively increased, and thus an image failure such a chip of the back end of the image or a faint horizontal thin line is likely to occur.

Although in the embodiment shown in FIG. 1, the five magnetic poles are incorporated into the development sleeve 3, in order to, for example, further increase the amount of movement of the developer in the development region and further enhance the pumping, it is naturally possible to increase the number of magnetic poles to 8, 10 or 12.

### EXAMPLES

### Example 1

### Production of the Ferrite Particles

Mn-based ferrite particles were produced by the following method. As starting materials, 3400 g of Fe₂O₃, 1600 g of Mn₃O₄ and 32 g of SrCO₃ were dispersed in 230 0 g of water, as a dispersant, 30 g of polycarboxylate ammonium-based dispersant was added and a mixture was obtained. The mixture was milled with a wet ball mill (media diameter; 2 mm), and a mixed slurry was obtained.

The mixed slurry was sprayed into hot air of approximate 180° C. by a spray drier (the number of revolutions of the disc; 20,000 rpm), and a dried pelletized product having a particle diameter of 10 to 200 μm was obtained. Form the pelletized product, coarse particles were separated with a 91 μm mesh sieve screen, and minute particles were separated with a 37 μm mesh sieve screen.

The pelletized powder was put into an electric furnace in an air atmosphere, and was burned at 1200° C. for three hours. The burned product thus obtained was disintegrated with a hammer mill, and was classified with a vibration sieve, and ferrite particles having an average particle diameter of 35 μm were obtained. The apparent density, the fluidity after magnetization under a magnetic field of 1000/(4π) kA/m (1000 oersteds) and the magnetic property of the obtained ferrite particles were measured by the following methods. The results of the measurements are shown in table 1.

(The Content of the Sr Element or the Ca Element)

The ferrite particles were dissolved in an acid solution, the concentration of Sr and the concentration of Ca were measured with an ICP emission spectrometer (“ICPS-7510” made by Shimadzu Corporation) and furthermore, they were subjected to oxide conversion and the results were determined.

(Apparent Density)

The apparent density of the ferrite particles was measured according to JIS Z 2504.

(Fluidity)

The fluidity of the ferrite particles before being magnetized was measured according to JIS Z 2502.

Furthermore, the ferrite particles were made to pass through the magnetic field of 1000/(4π) kA/m (1000 oersteds) produced with a permanent magnet, and the fluidity after five minutes elapsed was measured in the same manner as described above.

(Magnetic Property)

A room temperature vibrating sample magnetometer (VSM) (“VSM-P7” made by Toei Industry Inc.) was used to measure magnetization, and the residual magnetization rr (Am²/kg) when the maximum magnetic field of 10000/(4π) kA/m (10000 oersteds) was applied was measured.

(Production of the Carrier)

450 weight parts of a silicone resin and 9 weight parts of (2-aminoethyl)aminopropyl trimethoxysilane were dissolved in 450 weight parts of toluene serving as a solvent, and thus a coat solution was produced. 50000 weight parts of the ferrite particles produced were coated with the coat solution using a fluidized bed type coating device, and were heated in an electric furnace at a temperature of 300° C. for one hour, with the result that a coating carrier having a layer thickness of 0.8 μm was produced.

(Production of the Toner)

450 g of a 0.1 mol sodium phosphate aqueous solution was put into 710 g of dionized water, and was heated to 60° C., and was thereafter agitated at 12000 rpm with a TK homomixer. 68 g of a 1.0 mol calcium chloride aqueous solution was gradually added to the resulting solution, and thus an aqueous medium containing calcium phosphate was produced.

On the other hand, 170 g of styrene, 30 g of n-butyl acrylate, 30 g of a pigment, 2 g of a di-t-butyl salicylic acid metal compound and 10 g of a polyester resin were dissolved and dispersed with the TK homomixer, then 10 g of 2,2′-azobis (2,4-dimethyl valeronitrile) was dissolved as a polymerization initiator and a polymerizable monomer composition was produced.

The polymerizable monomer composition was put into the aqueous medium produced, was agitated at a temperature of 60° C. in an atmosphere of nitrogen at 10000 rpm for 20 minutes with the TK homomixer, the particles of the polymerizable monomer composition are increased, then the temperature was increased to 80° C. while agitation was being performed with an agitation blade and the reaction was performed for 10 hours. After the completion of the polymerization reaction, part of the aqueous medium was distilled off under reduced pressure, cooling was performed, hydrochloric acid was added, calcium phosphate was dissolved, then filtration, water washing and drying were performed and toner particles having an average particle diameter of 7 μm were produced. 100 g of hydrophobic silica whose particle diameter was 0.3 μm and 100 g of hydrophobic titanium whose particle diameter was 0.3 μm were externally added to the toner particles produced, with the result that the toner was produced.

(Production of the Two-Component Developer)

95 weight parts of the coating carrier and 5 weight parts of the toner that were produced were mixed with a tumbler mixer to produce the two-component developer.

(Image Density Measurement)

The two-component developer produced was put into the development device having a structure shown in FIG. 1 (the circumferential velocity Vs of the development sleeve: 406 mm/sec, the circumferential velocity Vp of the photoconductive drum: 205 mm/sec, the photoconductive drum-to-development sleeve distance: 0.3 mm) to form a black solid image, its density was measured with a reflection densitometer (model No. TC-6D made by Tokyo Denshoku Co., Ltd.) and evaluation was performed according to the following criteria. The results are shown in table 1.

“Excellent”: more than 1.4

“Fair”: 1.2 to 1.4

“Poor”: less than 1.2

### Example 2

The ferrite particles and the coating carrier were produced in the same manner as in example 1 except that 160 g of SrCO₃ was added, and the image density was measured and evaluated. The results are shown in table 1.

### Example 3

The ferrite particles and the coating carrier were produced in the same manner as in example 1 except that 22 g of CaCO₃ was added instead of SrCO₃, and the image density was measured and evaluated. The results are shown in table 1.

### Example 4

The ferrite particles and the coating carrier were produced in the same manner as in example 1 except that 109 g of CaCO₃ was added instead of SrCO₃, and the image density was measured and evaluated. The results are shown in table 1.

### Comparative Example 1

The ferrite particles and the coating carrier were produced in the same manner as in example 1 except that SrCO₃ was not added, and the image density was measured and evaluated. The results are shown in table 1.

### Examples 5 to 8

The ferrite particles and the coating carrier were produced in the same manner as in examples 1 to 4 except that the burning temperature of the pelletized powder was 1000° C., and the image density was measured and evaluated. The results are shown in table 1.

### Example 9

Mn—Mg based ferrite particles were produced by the following method. As starting materials, 3440 g of Fe₂O₃, 1480 g of Mn₃O₄, 90 g of MgO and 16 g of SrCO₃ were dispersed in 2300 g of water, as a dispersant, 30 g of polycarboxylate ammonium-based dispersant was added and a mixture was obtained. The mixture was milled with the wet ball mill (medium diameter; 2 mm), and a mixed slurry was obtained.

Then, the ferrite particles, the coating carrier and the developer were produced in the same manner as in example 1, and the image density was measured and evaluated. The results are shown in table 1.

### Example 10

The ferrite particles and the coating carrier were produced in the same manner as in example 9 except that 160 g of SrCO₃ was added, and the image density was measured and evaluated. The results are shown in table 1.

### Example 11

The ferrite particles and the coating carrier were produced in the same manner as in example 1 except that 109 g of CaCO₃ was added instead of SrCO₃, and the image density was measured and evaluated. The results are shown in table 1.

TABLE 1

| | | | | | Apparent | Fluidity (sec) | | Residual | |
|---|---|---|---|---|---|---|---|---|---|
| | | | Content | Burning tem. | density | Before | After | magnetization σr | Image |
| | Composition | Element | (weight %) | (° C.) | (g/cm3) | magnetization | magnetization | (A · m2/kg) | density |
| Example 1 | MnFe₂O₄ | Sr | 0.4 | 1200 | 2.27 | 29.1 | 30.0 | 0.8 | Fair |
| Example 2 | MnFe₂O₄ | Sr | 1.9 | 1200 | 2.42 | 28.6 | 33.7 | 1.3 | Fair |
| Example 3 | MnFe₂O₄ | Ca | 0.2 | 1200 | 2.35 | 28.3 | 28.8 | 0.6 | Fair |
| Example 4 | MnFe₂O₄ | Ca | 0.9 | 1200 | 2.35 | 28.6 | 33.1 | 1.5 | Fair |
| Example 5 | MnFe₂O₄ | Sr | 0.4 | 1000 | 2.04 | 31.6 | 39.5 | 1.3 | Excellent |
| Example 6 | MnFe₂O₄ | Sr | 1.9 | 1000 | 1.88 | 37.7 | 47.2 | 3.1 | Excellent |
| Example 7 | MnFe₂O₄ | Ca | 0.2 | 1000 | 2.04 | 32.4 | 39.4 | 1.2 | Fair |
| Example 8 | MnFe₂O₄ | Ca | 0.9 | 1000 | 1.84 | 40.5 | 60 [symbol] | 3.5 | Excellent |
| Example 9 | Mn_{0.9}Mg_{0.1}Fe₂O₄ | Sr | 0.1 | 1200 | 2.25 | 27.1 | 29.5 | 0.9 | Fair |
| Example 10 | Mn_{0.9}Mg_{0.1}Fe₂O₄ | Sr | 1.9 | 1200 | 2.22 | 26.4 | 31.2 | 1.2 | Fair |
| Example 11 | Mn_{0.9}Mg_{0.1}Fe₂O₄ | Ca | 0.9 | 1200 | 2.18 | 28.1 | 33.5 | 0.8 | Fair |
| Comparative | MnFe₂O₄ | — | — | 1200 | 2.45 | 26.1 | 25.7 | 0.5 | Poor |
| example 1 | | | | | | | | | |
| Comparative | MnFe₂O₄ | — | — | 1000 | 2.24 | 28.1 | 30.1 | 0.8 | Poor |
| example 2 | | | | | | | | | |

As is obvious from table 1, in the developer using the carrier of examples 1 to 11 that contained 0.1 to 2.5 weight percent of the Sr element or the Ca element, the image density where there was no problem in practical use was obtained. On the other hand, in the developer using the carrier of comparative examples 1 and 2 that did not contain the Sr element or the Ca element, in practical use, there was a problem in which the image density was less than 1.2.

### INDUSTRIAL APPLICABILITY

When the ferrite particles of the present invention are used as the carrier, even if the image formation speed is increased, a sufficient image density is usefully obtained.

### LIST OF REFERENCE SYMBOLS

3 development sleeve
5 photoconductive drum
C carrier

1. Ferrite particles,
wherein a material expressed as a composition formula M_{X}Fe_{3-X}O₄ (where M is at least one of Mg and Mn, and 0≦X≦1) is a main component, and as a total amount, 0.1 to 2.5 weight percent of at least one of a Sr element and a Ca element is contained.

2. The ferrite particles of claim 1,
wherein a fluidity of the ferrite particles magnetized under a magnetic field of 1000/(4π) kA/m (1000 oersteds) is 40 seconds or more.

3. The ferrite particles of claim 1,
wherein a residual magnetization or is 3 Am²/kg or more.

4. An electrophotographic carrier,
wherein a surface of the ferrite particles of claim 1 is coated with a resin.

5. An electrophotographic developer comprising:
the electrophotographic carrier of claim 4; and
a toner.

6. The ferrite particles of claim 2,
wherein a residual magnetization σr is 3 Am²/kg or more.

7. An electrophotographic carrier,
wherein a surface of the ferrite particles of claim 2 is coated with a resin.

8. An electrophotographic carrier,
wherein a surface of the ferrite particles of claim 3 is coated with a resin.

9. An electrophotographic carrier,
wherein a surface of the ferrite particles of claim 6 is coated with a resin.

10. An electrophotographic developer comprising:
the electrophotographic carrier of claim 7; and
a toner.

11. An electrophotographic developer comprising:
the electrophotographic carrier of claim 8; and
a toner.

12. An electrophotographic developer comprising:
the electrophotographic carrier of claim 9; and
a toner.
